(19) United States
(12) Patent Application Publication
(10) Pub. No.: US 2011/0174177 A1
(43) Pub. Date: Jul. 21, 2011

(54) SHEET CHUCK, AND MICROCONTACT PRINTING PROCESS USING THE SAME

(75) Inventors: Hiroshi FUJITA, Tokyo (JP); Mitsutaka NAGAE, Shinjuku-ku (JP)

(73) Assignee: DAI NIPPON PRINTING CO., LTD., TOKYO (JP)

(21) Appl. No.: 13/008,493

(22) Filed: Jan. 18, 2011

(30) Foreign Application Priority Data
Jan. 20, 2010 (JP) 2010-010007

(51) Int. Cl. B41F 21/06; B41F 21/04

(52) U.S. Cl. 101/407.1; 101/483

(57) ABSTRACT

The objects of the invention are to provide a sheet chuck that enables a flexible sheet substrate to come in uniform contact with a stamp, and a microcontact printing process of using that sheet chuck to form a high-precision pattern. The sheet chuck of the invention comprises a base having a sheet substrate carrying surface defined by an upper surface thereof, a suck-in/suck-out port positioned on the carrying surface, and a holder positioned on the carrying surface in such a way as to surround the suck-in/suck-out port, and the suck-in/suck-out port is an area capable of sucking in or sucking out gas.

### BACKGROUND OF THE INVENTION

1. Field of the Invention

The present invention relates generally to a sheet chuck and a microcontact printing process, and more specifically to a sheet chuck for holding a flexible sheet substrate in place and a microcontact printing process using the same.

2. Description of the Prior Art

Micropatterning technology of micro-orders to nano-orders includes soft lithography that is a technique used to cast a fluid material such as silicone resin into a micromold and cure it just there for transfer of fine 3D structures. Patterning technology using as a plate a resin mold obtained by this soft lithography includes microcontact printing (hereinafter also referred to as the μCP process).

The μCP process is a micropatterning technique developed in 1993 by G. M. Whitesides et al., Harvard University, USA. According to this micropatterning technique, a fluid material such as polydimethylsiloxane (PDMS: a two-pack type curable silicone resin) is cast and cured on a master plate prepared by soft lithography on a silicon, quartz or other substrate, and the cured PDMS is then separated away from the master plate to prepare a PDMS stamp having a flipped-over pattern of that stamp. Thereafter, ink is placed on the transfer convexities of the stamp to transfer it onto an application member that is placed and held on a sheet chuck.

When that μCP process is used to form the desired pattern on a flexible sheet substrate, direct placement of the flexible sheet substrate on the surface of the sheet chuck may give rise to poor transfer of ink from the stamp onto the sheet substrate, because neither of the surfaces of the sheet substrate and the transfer convexities of the stamp are in an ideal plane state, rendering contact of both uneven. To prevent such poor contact of the sheet substrate and the transfer convexities, it has been proposed to interpose an elastic material such as urethane rubber or sponge sheet between the sheet chuck and the flexible sheet substrate (JP(A) 2009-208413).

However, when there is a density difference across the stamp, for instance when there is a noticeable difference in the density of transfer convexities or there is inconvenience to the elastic material such as poor processing precision about thickness or the like or elasticity deterioration with time, poor contact occurs locally, giving rise to poor transfer of ink from the stamp onto the sheet substrate, and pattern size fluctuations as well. When the sheet substrate is placed by its own weight on the elastic material, on the other hand, the sheet substrate often slips over the elastic material, and such sheet material slippage poses another problem: alignment precision deterioration.

### SUMMARY OF THE INVENTION

An object of the present invention is to provide a sheet chuck capable of bringing a flexible sheet substrate in uniform contact with an associated stamp, and a microcontact printing process for forming a high-definition pattern using that sheet chuck.

According to the invention, such an object is accomplished by the provision of a sheet chuck comprising a base having a sheet substrate carrying surface defined by an upper surface thereof, a suck-in/suck-out port positioned on said carrying surface, and a holder positioned on said carrying surface in such a way as to surround said suck-in/suck-out port, wherein said suck-in/suck-out port is an area capable of sucking in or sucking out gas.

In another embodiment of the inventive sheet chuck, the surface of said suck-in/suck-out port extends up from the surface of said holder by a height of 0 to 5 μm.

In yet another embodiment of the inventive sheet chuck, said suck-in/suck-out port comprises a recess and a porous material positioned in such a way as to close up the opening of said recess, wherein said recess communicates with outside said base by way of a gas flow channel or, alternatively, said suck-in/suck out port comprises a recess and a sheet-like material positioned in such a way as to close up the opening of said recess, wherein said recess communicates with outside said base by way of a gas flow channel, said sheet-like material having a plurality of through-holes.

In a further embodiment of the inventive sheet chuck, said holder comprises an elastic member in such a configuration as to surround said suck-in/suck-out port, wherein said elastic material extends up from said holder by a height of up to 20 μm.

In a further embodiment of the inventive sheet chuck, said elastic member is positioned in a groove present in said holder or fixed onto the surface of said holder.

The inventive mioroconact printing process comprises the steps of:

placing a sheet substrate on any one of the above sheet chucks in such a way as to cover up said suck-in/suck-out port with a periphery thereof positioned at said holder,

locating a gap keeper frame onto the sheet substrate positioned at said holder,

sucking in a gas from said suck-in/suck-out port to hold said sheet substrate by suction at said suck-in/suck-out port,

providing a microcontact printing stamp comprising a stamp, transfer convexities formed on said base, and a dummy convex portion positioned at said base in an area around a site having said transfer convexities formed on it, and feeding ink to said transfer convexities of said microcontact printing stamp and implementing alignment of said stamp with said sheet substrate, after which said stamp draws close to said sheet substrate until said dummy convex portion is in abutment onto said gap keeper frame,

sucking out the gas from said suck-in/suck-out port to permit the sheet substrate positioned inside with respect to said gap keeper frame to displace toward said stamp, coming into contact with the ink being fed to said transfer convexities, and

sucking in the gas from said suck-in/suck-out port to space said sheet substrate away from said stamp for transfer of said ink onto said sheet substrate, and holding said sheet substrate at said suck-in/suck-out port and spacing said stamp away.

In another embodiment of the inventive microcontact printing process, a sheet chuck having an elastic member at said holder is used in combination with a gap keeper frame in such a configuration as to be positioned on said elastic member via the sheet substrate.

In yet another embodiment of the inventive micro-contact printing process, said gap keeper frame has a uniform thickness in the range of 20 to 70 μm.

### BRIEF DESCRIPTION OF THE DRAWINGS

FIG. 1 is illustrative in perspective of one embodiment of the inventive sheet chuck.

FIG. 2 is illustrative in section of the sheet chuck of FIG. 1 as taken on I-I line.

FIG. 3 is illustrative in section, as in FIG. 2, of another embodiment of the inventive chuck sheet.

FIG. 4 is illustrative in section, as in FIG. 2, of yet another embodiment of the inventive chuck sheet.

FIGS. 5A and 5B are illustrative in section, as in FIG. 2, of a further embodiment of the inventive sheet chuck.

FIGS. 6A, 6B and 6C are illustrative of the process steps of one embodiment of the inventive microcontact printing process.

FIGS. 7A and 7B are illustrative of the process steps of one embodiment of the inventive microcontact printing process.

FIG. 8 is illustrative of positional relations between the gap keeper frame, the sheet substrate and the elastic member of the sheet chuck.

### DETAILED DESCRIPTION OF THE INVENTION

Some embodiments of the invention are now explained with reference to the accompanying drawings.

### [Sheet Chuck]

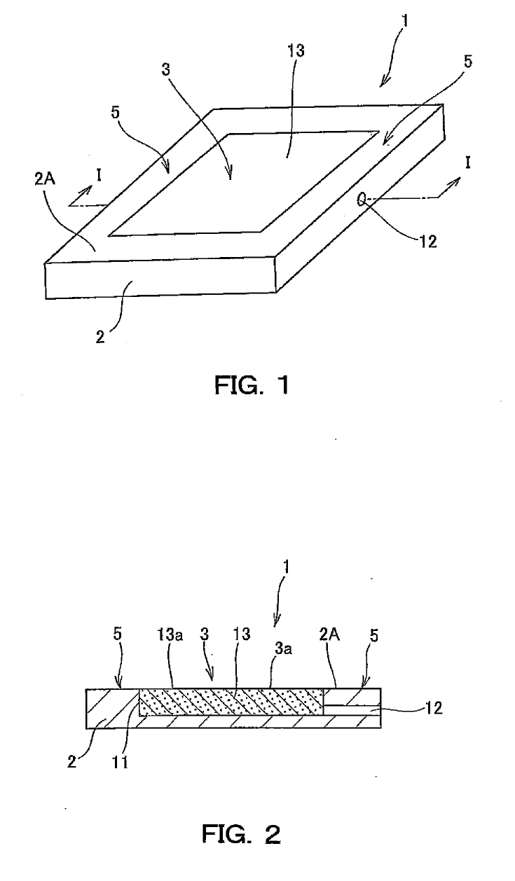

FIG. 1 is illustrative in perspective of one embodiment of the inventive sheet chuck, and FIG. 2 is illustrative in section of the sheet chuck of FIG. 1 as taken on I-I line. In FIGS. 1 and 2, a sheet chuck 1 of the invention comprises a base 2 having an upper surface that defines a sheet substrate carrying surface 2A, a suck-in/suck-out port 3 positioned on the carrying surface 2A, and a holder 5 positioned on the carrying surface 2A in such a way as to surround the suck-in/suck-out port 3.

The suck-in/suck-out port 3 comprises a recess 11 formed in the base 2 and a porous material 13 positioned in such a way as to close up the opening of the recess 11, and the recess 11 communicates with outside the base 2 by way of a gas flow channel 12. In the illustrated embodiment, the porous material 13 conforming in shape to the recess 11 is fitted into it to close up the opening of the recess 11; however, the invention is never limited to it. For instance, the porous material 13 thinner than the depth size of the recess 11 may be located on the upper portion of the recess 11 (closer to the carrying surface 2A) to close up the opening of the recess 11. And the gas flow channel 12 is connected to pumping equipment (not shown) or the like, thereby making it possible to suck in gas from the surface 13a of the porous material 13 or suck out gas. Such suck-in/suck-out port 3 should preferably have its surface 3a (the surface 13a of the porous material 13 in the illustrated embodiment) extending up from the holder 5 by a height in the range of 0 to 5 μm. As the height of the surface 3a of the suck-in/suck-out portion 3 extending up from the holder 5 is less than 0 μm, that is, as the surface 3a of the suck-in/suck-out port 3 is lower than the holder 5, it may often do damage to the stability of the sheet substrate upon holding by suction. A height of greater than 5 μm, on the other hand, is not preferable, because it may often cause locally high sites of the transfer convexities of such a stamp as used in the inventive microcontact printing process to be described later to abut against the base.

The above holder 5 provides a site where the periphery of the sheet substrate carried on the sheet chuck 1 is positioned (by the “periphery” is meant the area around the site where a pattern corresponding to the transfer convexities of the stamp used for microcontact printing is to be formed by transfer). Such holder 5 should preferably be free of undulations or flat; for instance, R_{P-V} should desirously be 10 μm or less, preferably 1.0 μm or less. It is not preferable that there are undulations having an R_{P-V} of greater than 10 μm in the holder 5, because during the inventive microcontact printing process to be described later, there will be unnecessary contact of the sheet substrate with the stamp, which will in turn render stabilized implementation of microcontact printing difficult. It is here to be noted that R_{P-V} should be measured under non-contact conditions on a CNC 3D image measuring system.

The base 2 forming a part of the sheet chuck 1 may be made typically of a metallic material such as aluminum or stainless steel, a ceramic material such as alumina or zirconia, a glass material or the like. The size and shape of the carrying surface 2A of the base 2 as well as the opening size and shape of the recess 11 may be properly determined in conformity to the size and shape of the sheet substrate to be held, the size and shape of the area where the pattern is to be formed on the sheet substrate, etc. The depth of the recess 11 may be determined with the thickness of the porous material 13 in mind, depending on whether the whole recess 11 is filled up by the porous material 13 as described above or only the opening is closed up by the porous material 13; for instance, that depth may optionally be set at about 1.0 to 5.0 mm. In the illustrated embodiment, one single gas flow channel 12 is provided in such a way as to extend all the way between the inside wall surface of the recess 11 and the outside wall surface of the base 2; however, there is no limitation to how many gas flow channels 12 are provided and where they are provided. For instance, a plurality of gas flow channels 12 may be provided through a plurality of sites or the same site of the base 2. Alternatively, the gas flow channel 12 may be divided within the base 2 into sub-channels such that the opening ends of the sub-channels positioned on the recess 11 side are found on the inside wall surface of the recess 11. Yet alternatively, the opening end of the gas flow channel 12 positioned on the recess 11 side may be positioned at the bottom of the recess 11.

The porous material 13 forming a part of the sheet chuck 1 has a structure such that the gas sucked in from the surface 13a arrives at the gas flow channel 12 through inside whereas the gas sent out of the gas flow channel 12 onto the recess 11 passes through the porous material 13, leaving the surface 13a. Such porous material 13, for instance, may be made of a partially fired powdery ceramic or metallic material that is chemically or physically treated to have micropores inside. Alternatively, a naturally occurring material having a porous structure may also be used to this end. The surface 13a of the porous material 13 must have flatness good enough to hold the sheet substrate by suction with no difficulty; for instance, it is desired for R_{P-V} to be 10 μm or less, preferably 1.0 μm or less. It is here to be noted that R_{P-V} may be measured under the same conditions as described above.

It is possible to set the porous material 13 up in the recess 11 by using the adhesive, the welding or the like.

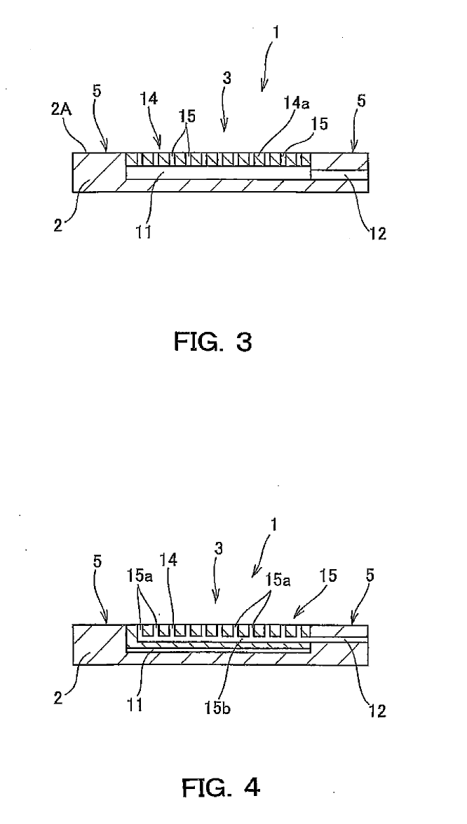

Instead of the porous material 13 forming the suck-in/suck-out port 3, the inventive sheet chuck may comprise a sheet-like material having a plurality of through-holes. FIG. 3 is illustrative in section, as in FIG. 2, of such an embodiment of the inventive chuck sheet. The inventive sheet chuck 1 shown in FIG. 3 is provided with a sheet-like material 14 having a plurality of through-holes in such a way as to close up the upper portion (closer to the carrying surface 2A) of the recess 11 in the substrate 2. Apart from that, the sheet chuck here is much the same as shown in FIGS. 1 and 2, with like parts or members indicated by light numerals.

The single requirement for the through-holes 15 in the sheet-like material 14 is that gas is passable in the process of sucking gas from the gas flow channel 12 in the recess 11 or sucking gas out of the recess 11, and holding of the sheet substrate is ensured during suction of gas with uniform displacement of the sheet substrate during sucking-out of gas; there is no limitation on the inside diameter and inside wall surface shape of the through-holes and on how many through-holes are provided. For instance, the sheet-like material 14 having through-holes of about 50 to 300 μm in inside diameter at a density of about 1 to 10/cm².

The sheet-like material 14, for instance, may be made of aluminum, copper, brass, stainless steel, titanium, alumina, zirconia, and glass, and the through-holes 15 may each be provided by chemical or physical treatment. As is the case with the above porous material 13, the sheet-like material 14 should preferably have its surface 14a extending from above the holder 5 by a height of 0 to 5 μm. The surface 14a of the sheet-like material 14 should preferably have flatness good enough to hold the sheet substrate by suction with no difficulty; for instance, it is desired for R_{P-V} to be 10 μm or less, preferably 1.0 μm or less. R_{P-V} may be measured under the same conditions as described above.

While the above sheet-like material 14 has the through-holes 15 formed along its thickness direction, it is to be understood that their shape is never limited to it. As shown in FIG. 4 as an example, a plurality of longitudinal holes 15a extending from the surface 14a of the sheet-like material 14 down to a given depth in its thickness direction may be provided in such a way as to communicate with a lateral hole 15b provided in the sheet-like material 14. In this example, the lateral hole 15b is connected with the gas flow channel 12.

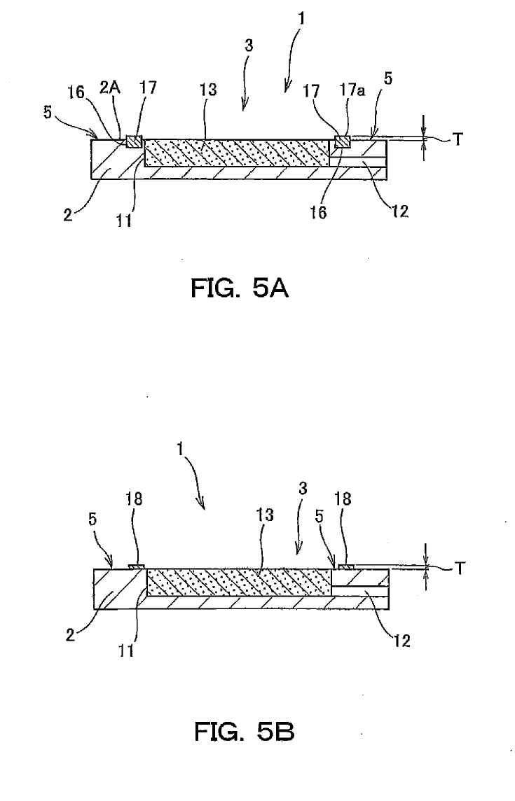

In an alternative embodiment of the inventive sheet chuck, the holder 5 may have a frame-form elastic member at the holder 5 in such a way as to surround the suck-in/suck-out port 3. FIGS. 5A and 5B are illustrative in section, as in FIG. 2, of such embodiments of the inventive sheet chuck. The inventive sheet chuck 1 shown in FIG. 5A has a frame-form groove 16 formed in the holder 5 in such a way as to surround the suck-in/suck-out port 3, and there is an elastic member 17 provided in that groove 16. The inventive sheet chuck 1 shown in FIG. 5B has a frame-form elastic member 18 fixed onto the surface of the holder 5 in such a way as to surround the suck-in/suck-out port 3. The sheet chucks 1 shown in FIGS. 5A and 5B are much the same as that shown in FIGS. 1 and 2 except that one has the combined groove 16/elastic member 17, and another has the elastic member 18, with like members indicated by like numerals.

Preferably in such chuck sheets 1 as shown in FIGS. 5A and 5B, the elastic member 17, 18 extends up from the holder 5 by a height T of up to 20 μm. The thickness T exceeding 20 μm is not preferable because there is damage to the stability of the sheet substrate upon holding by suction. Thus, allowing the holder 5 to have the elastic member 17, 18 makes surer the sheet substrate is held by suction of gas from the suck-in/suck-out port 3, and makes further improvement in the precision of displacement control for the sheet substrate due to the release of gas from the suck-in/suck-out port 3. For the elastic member 17 shown in FIG. 5A, it is not preferable that the upper surface 17a becomes lower than the holder 5, because the elastic member 17 is rid of its own effect.

The above elastic member 17, 18, for instance, may be made of a material having a rubber hardness ranging from 30 to 60 on durometer type E. For instance, there is the mention of silicone rubber such as polydimethylsiloxane (PDMS), and nitrile rubber. The frame shape of the elastic member 17, 18 may be properly determined in conformity to the size and shape of the sheet substrate such that it is positioned at the periphery of the sheet substrate carried on the sheet chuck 1 (the area around the site where the pattern corresponding to the transfer convexities of the stamp used in microcontact printing is to be formed by transfer). The width of the elastic member 17, 18 may be properly chosen from the range of about 2.0 to 5.0 mm as an example.

As a matter of course, the sheet chucks shown in FIGS. 3 and 4 may also have such elastic member 17, 18.

Such an inventive sheet chuck enables the sheet substrate to be held by suction on the suck-in/suck-out port 3 so that the sheet substrate can be kept from slipping over the sheet chuck. As compared with a conventional arrangement wherein the sheet substrate is held by its own weight on a sheet chuck built up of an elastic material, therefore, there are some considerable improvements introduced in the precision and reliability of alignment with the stamp in microcontact printing. While the sheet substrate is engaged with the holder 5, the gas is sucked out of the suck-in/suck-out port 3 so that the sheet substrate can be displaced, thereby engaging the sheet substrate with the stamp for micro-contact printing at uniform pressure yet without being affected by a density difference in the transfer convexities of the stamp for microcontact printing. It is thus possible to prevent poor ink transfer and pattern size fluctuations upon microcontact printing, which are caused by deterioration with time of a conventional sheet chuck made of an elastic material. In addition, the provision of the elastic material at the holder makes surer the sheet substrate is held by sucking in gas from the suck-in/suck-out port, and introduces further improvements in the precision of displacement control of the sheet substrate by the release of gas out of the suck-in/suck-out port.

By way of illustration but not by way of limitation, the present invention has been explained with reference to some embodiments.

It is here to be noted that the sheet substrate to be held in place by the inventive sheet chuck, for instance, may include a resinous sheet having a thickness in the range of about 50 to 150 μm, a metallic sheet having a thickness in the range of about 30 to 100 μm, a paper or unwoven fabric sheet having a thickness in the range of about 50 to 150 μm, and a carbon or glass fiber cloth sheet impregnated with resin to get rid of air permeability. In addition, these sheets may be provided as desired with lines, textures or patterns such as wirings, terminals or devices.

### [Microcontact Printing Process]

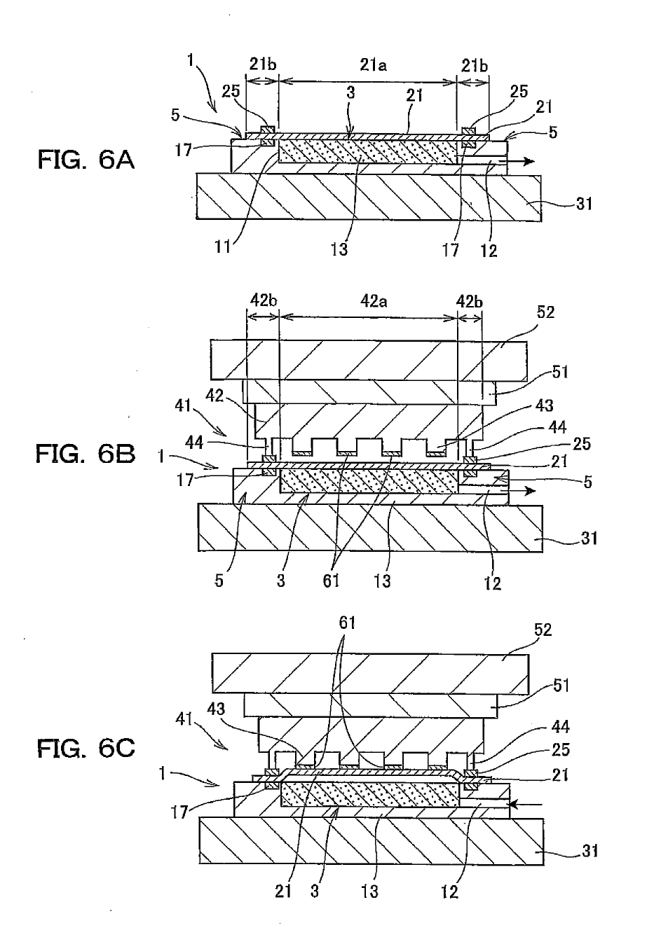

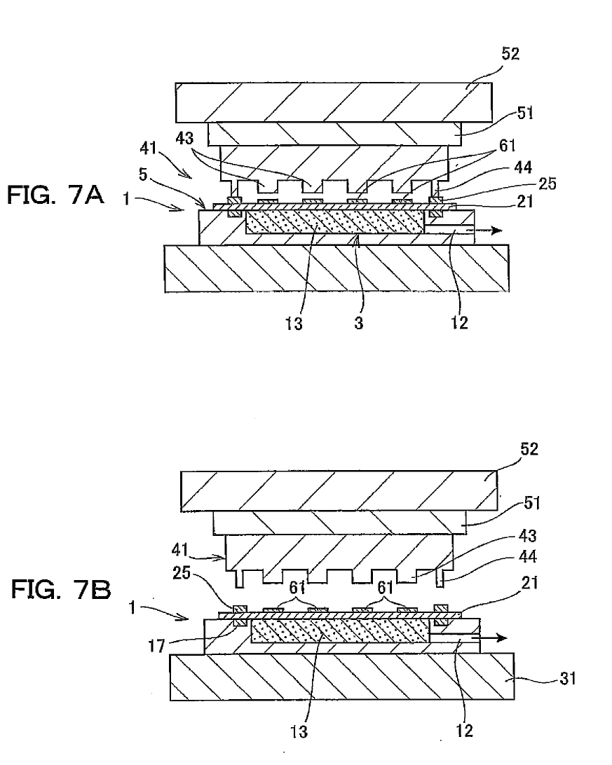

FIGS. 6A to 6C and FIGS. 7A and 7B are illustrative of one embodiment of the inventive microcontact printing process; more specifically, they show one example using the inventive stamp 1 shown in FIG. 5A. Referring first to FIG. 6A, the inventive sheet chuck 1 is mounted on a stage 31. A sheet substrate 21 is carried at the suck-in/suck-out port 3 of the sheet chuck 1 such that its periphery 21b (an area around a site 21a where the pattern commensurate with the transfer convexities 43 of a stamp 41 used in microcontact printing are to be formed by transfer) is positioned at the holder 5, and a gap keeper frame 25 is placed on the periphery 21b of the sheet substrate 21 positioned at the holder 5. Then, pumping equipment (not shown) connected with the gas flow channel 12 is activated to suck in gas from the suck-in/suck-out port 3 to hold the sheet substrate 21 by suction at the suck-in/suck-out port 3. It is here to be noted that the order of placing the gap keeper frame 25 onto the periphery 21b of the sheet substrate 21 and holding the sheet substrate 21 by suction at the suck-in/suck-out port 3 may be the opposite.

The requirement for the sheet substrate used in the inventive microcontact printing process is that it is of flexibility enough to be displaceable by the release of gas from the suck-in/suck-out port 3 in the direction of the microcontact printing stamp 41 at the step to be described later. For instance, there is the mention of a resinous sheet having a thickness in the range of about 50 to 150 μm, a metallic sheet having a thickness in the range of about 30 to 100 μm, a paper or unwoven fabric sheet having a thickness in the range of about 50 to 150 μm, and a carbon or glass fiber cloth sheet impregnated with resin to get rid of air permeability. In addition, these sheets may be provided as desired with lines, textures or patterns such as wirings, terminals or devices.

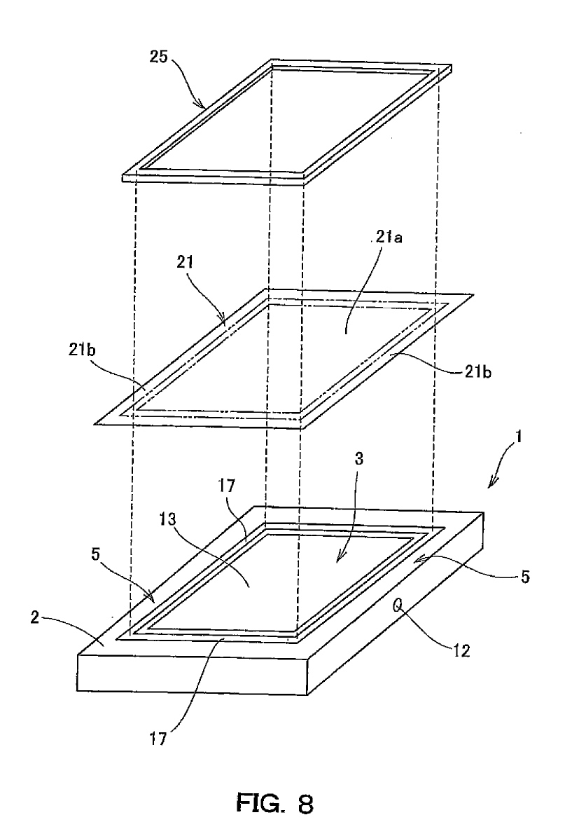

The above gap keeper frame 25 is a member that makes sure the desired gap between ink fed to the transfer convexities 43 of the stamp 41 and the sheet substrate 21 at the step to be described later; it is configured in such a way as to be opposite to the elastic member 17 of the sheet chuck 1 via the periphery 21b of the sheet substrate 21. FIG. 8 illustrates the positional relations between the gap keeper frame 25, the sheet substrate 21 and the elastic member 17 of the sheet chuck 1, showing the respective parts as taken apart. It is here to be noted that in FIG. 8, a frame-form area where the elastic member 17 and the gap keeper frame 25 abut upon the sheet substrate 21 is indicated by a two-dot chain line at the sheet substrate 21.

The thickness of the gap keeper frame 25 determines the size of the gap provided between ink 61 being fed to the transfer convexities 43 of the stamp 41 and the sheet substrate 21. Such gap keeper frame 25 may have a thickness in the range of about 20 to 70 μm as an example, with a thickness variation of up to 10 μm, preferably up to 2 μm. Departures of the thickness of the gap keeper frame 25 from the above range or thickness variations of greater than 10 μm are not preferable, because as the stamp 41 draws close to the sheet substrate 21, there is unnecessary contact of the sheet substrate 21 with the ink 61, or there is damage by displacement to uniform contact of the sheet substrate 21 with the ink 61. Such gap keeper frame 25, for instance, may be made of polyethylene naphthalate, polycarbonate, and polyethylene terephthalate, and its width may be properly determined in the range of 3 to 15 mm as an example.

On the other hand, the microcontact printing stamp 41 formed on a support substrate 51 is attached to a stamp holder 52 to feed the ink 61 to the transfer convexities 43 of the stamp 41. The stamp 41 has a base 42, the transfer convexities 43 extending from a pattern area 42a of the base 42, and a dummy convex portion 44 extending from the periphery 42b of the base 42. Then, the stage 31 is adjusted for alignment of the stamp 41 with the sheet substrate 21, after which the stamp 41 draws close to the sheet substrate 21 until the dummy convex portion 44 abuts upon the gap keeper frame 25 (FIG. 6B).

The dummy convex portion 44 of the stamp 41 has its end flush with (or shared by) the upper surfaces of the transfer convexities 43, and as the dummy convex portion 44 abuts upon the gap keeper frame 25 as illustrated, it brings the approach of the stamp 41 to the sheet substrate 21 to a stop, making sure the desired gap between the ink 61 being fed to the transfer convexities 43 and the sheet substrate 21. It also brings the periphery 21b of the sheet substrate 21 in engagement with the holder 5. Such dummy convex portion 44 may be formed of a plurality of columnar, conical, pyramidal, truncated conical, truncated pyramidal or other convexities arranged at the desired interval or, alternatively, it may be configured in conformity with the shape of the gap keeper frame 25. Usually, alignment control of the stamp 41 and sheet substrate 21 may be implemented within the range of a few μm to several hundred μm, and the width of the gap keeper frame 25 is set at 3 to 15 mm as described above, making sure the abutment of the dummy convex portion 44 upon the gap keeper frame 25 even when there is a change by alignment in the relative positions of the stamp 41 and sheet substrate 21.

Then, the pumping equipment (not shown) connected with the gas flow channel 12 is activated to such the gas out of the suck-in/suck-out port 3. This in turn causes an area of the sheet substrate 2 (with the periphery 21b engaged with the holder 5) that is positioned inside with respect to the gap keeper frame 25 to displace slowly toward the stamp 41 by the gas sucked out of the suck-in/suck-out port 3 and eventually come into contact with the ink 61 at uniform pressures (FIG. 6C). The displacement speed of the sheet substrate 21 may be controlled by means of a flow meter and a regulator interposed between the pumping equipment (not shown) and the gas flow channel 12 and at the preset maximum flow rate and pressure.

Then, the pumping equipment (not shown) connected with the gas flow channel 12 is activated to suck in the gas from the suck-in/suck-out port 3 so that the sheet substrate 21 can be spaced away from the stamp 41, and held by suction at the suck-in/suck-out port 3 (FIG. 7A). In turn, the ink 61 fed to the transfer convexities 43 of the stamp 41 can be transferred onto the sheet substrate 21. Thereafter, the stamp 41 is spaced away (FIG. 7B), and the suction of the gas from the suck-in/suck-out port 3 is stopped. It is thus possible to obtain the sheet substrate having the pattern formed thereon commensurate with the transfer convexities 43 of the stamp 41.

With the inventive microcontact printing process used in combination with the inventive sheet chuck 1, it is possible to implement alignment of the sheet substrate 21 with the stamp 41 while the former is held by suction at the suck-in/suck-out port 3, resulting in much higher alignment precision and reliability. With the stamp 41 remaining in proximity to the sheet substrate 21 such that the dummy convex portion is in abutment upon the gap keeper frame 25, the gas is sucked out of the suck-in/suck-out port 3 to displace the sheet substrate 21 toward the stamp 41 so that the ink 61 can come into contact with the sheet substrate 21 at uniform pressures yet without being affected by the density differences of the transfer convexities 43. Further, it is possible to dispense with fine adjustment of engaging pressure in association with deterioration with time of a conventional sheet chuck made up of an elastic material, and contact of the ink 61 with the sheet substrate 21 can be stably reproduced by control of the gas sucked out of the suck-in/suck-out port 3. Furthermore, after contact of the ink 61 with the sheet substrate 21, the gas is sucked in from the suck-in/suck-out port 3 to space the sheet substrate 21 away from the stamp 41, so making sure the ink 61 fed to the transfer convexities 43 can be stably transferred onto the sheet substrate 21 for patterning with higher precision.

The inventive microcontact printing process as described above may also be implemented in combination with other embodiments of the inventive sheet chuck as shown in FIGS. 2, 3, 4 and 5B. It is here to be noted that when the sheet chuck having the elastic member 17, 18 at the holder 5 (see FIGS. 5A and 5B) is used in combination with the gap keeper frame 25 configured in conformity to that elastic member 17, 18, the sheet substrate 21 can be more reliably held by suction at the suck-in/suck-out port 3, and engagement of the sheet substrate 21 with the holder 5 by the dummy convex portion 44 via the gap keeper frame 25 can be more reliably implemented, ending up with improvements in the precision of displacement control of the sheet substrate 21 by the gas sucked out of the suck-in/suck-out port 3.

By way of illustration but not by way of limitation, the present invention has been explained with reference to the above embodiments.

The present invention is now explained in further details with reference to some specific experiments.

### Experimental Example 1

### Preparation of the Sheet Chuck

A 15-mm thick aluminum substrate (250 mm×350 mm) was provided for the base, one surface of which defined a carrying surface. A recess of 181 mm×271 mm and 5 mm in depth was formed by machining using a milling cutter at the central portion of the carrying surface of the base. Using a drill, a gas flow channel (of 3 mm in inside diameter) was drilled through from the outside wall surface of the base to the inside wall surface of the recess.

As a result of measuring the base having the thus formed recess and gas flow channel in terms of R_{P-V} of the holder around the recess, it has been found to be 1 μm or less, indicating that the holder is of undulation-free flatness. It is here to be noted that R_{P-V} was measured in a noncontact, optical way using a CNC 3D image measuring system.

A sintered alumina porous material (made by Yoshioka Co., Ltd.) was provided for the porous material. This porous material was polished on a lapping machine into a configuration of 181 mm×271 mm and 5 mm in thickness in conformity to the above recess configuration. As a result of measuring both its surfaces in terms of R_{P-V}, it has been found to be 5 μm or less, indicating that they are excellent in flatness. It is here to be noted that R_{P-V} was measured under the same conditions as described above.

Then, an adhesive was coated on the bottom of the recess formed in that base, and the porous material prepared as described above was fitted in and fixed to the recess. Thus, such inventive sheet shuck as shown in FIG. 2 was obtained. The surface (suck-in/suck-out port) of the porous material of that sheet chuck was flush with (or shared by) the periphery (holder) of the base.

### Preparation of the Stamp

A curable material (polydimethylsiloxane (PDMS: KE-106 commercially available from Shin-Etsu Chemical Co., Ltd., and composed of 90 grams of the main ingredient mixed with 9 grams of the curing agent) was cured on a glass substrate (300 mm×400 mm and 0.7 mm in thickness) serving as a support substrate to prepare a microcontact printing stamp having the base, transfer convexities and a dummy convex portion. This stamp has a transfer area of 160 mm×250 mm where dense sites, each having 157 transfer convexities of striped shape of 10 μm/10 μm in line/space and 20 mm in length, were scattered between coarse sites, each of 50 μm in width, thereby creating a density difference across the transfer area. The transfer convexities extended up from the base by a height of 5 μm. Further, the dummy convex portion was formed in a frame configuration of 215 mm×302 mm around the site with the transfer convexities formed on it, had a width of 10 mm, and extended up from the base by a height of 5 μm. It is here to be noted that the sizes of the member and the frame-form groove are measured from the center of the width of the member and groove. The same will apply hereinafter.

### Microcontact Printing

The thus prepared sheet chuck was placed on a stage, and a sheet substrate of 210 mm×297 mm (polycarbonate of 100 μm in thickness) was placed on the sheet chuck in such a way as to cover up its porous material (suck-in/suck-out port). Accordingly, the periphery of the sheet substrate was positioned at the holder of the sheet chuck.

Then, the gap keeper frame formed of polyethylene naphthalate was placed on the sheet substrate positioned at the holder. This gap keeper frame was in a frame configuration of 225 mm×312 mm, and had a width of 15 mm and a thickness of 50 μm. It is here to be noted that as a consequence of measuring the thickness of the gap keeper frame with a micrometer, it has been confirmed that there is a thickness variation of up to 1 μm, indicating that there is a uniform thickness.

Then, pumping equipment connected with the gas flow channel through the sheet chuck was activated to suck in gas from the porous material (suck-in/suck-out port) so that the sheet substrate was held by suction at the porous material (suck-in/suck-out port).

On the other hand, the microcontact printing stamp formed as described above was attached to a stamp holder, and ink (Ag nanoink) for forming an electrode pattern was spin coated on the transfer convexities of the stamp to feed the ink onto them. Thereafter, the ink was semi-dried at 23° C. for 1 minute. Then, the stage was adjusted for alignment of the stamp with the sheet substrate, after which the stamp was allowed to draw close to the sheet substrate until the dummy convex portion of the stamp was in abutment onto the gap keeper frame. In this state, the distance between the ink on the transfer concavities and the sheet substrate was about 50 μm.

Then, the pumping equipment connected with the gas flow channel through the sheet chuck was activated to suck the gas out of the porous material (suck-in/suck-out port), so that the sheet substrate positioned inside with respect to the porous material (suck-in/suck-out port) displaced slowly at a speed of about 5 μm/sec. toward the stamp by the gas sucked out of the porous material (suck-in/suck-out port), coming into contact with the ink on the transfer concavities.

Then, the pumping equipment connected with the gas flow channel through the sheet chuck was activated to suck in the gas from the porous material (suck-in/suck-out port) to space the sheet substrate away from the stamp, and hold it by suction at the porous material (suck-in/suck-out port), whereby the ink fed to the transfer convexities of the stamp was transferred onto the sheet substrate. Thereafter, the stamp was spaced away, the suction of the gas from the porous material (suck-in/suck-out port) was stopped, and drying was carried out at 180° C. for 30 minutes to form the electrode pattern.

Five sheet substrates subjected to similar electrode patterning were observed for the formed electrode patterns under an optical microscope. It has consequently been confirmed that there is an electrode width of 9.7 to 10.1 an obtained with very limited width variations, the reproducibility of stamp line width 10 μm is much more improved, and there is a uniform thickness of 252 to 267 nm obtained: the patterns are formed with much higher precision.

### Experimental Example 2

In the sheet chuck preparation step and before the formation of the recess, a groove of 4.0 mm in width and 3.98 mm in depth was formed in a 205 mm×292 mm frame configuration and position in such a way as to surround the recess. Then nitrile rubber of 4.0 mm in width and 4.0 mm in thickness was fitted in the groove to form an elastic member. Otherwise, Experimental Example 1 was followed to obtain such an inventive sheet chuck as shown in FIG. 5(A). The above groove was formed by mechanical cutting using a milling cutter, and the surface of the elastic member was flush with (shared by) the peripheral surface (holder) of the base.

Such a sheet chuck was used in combination with the same sheet substrate, microcontact printing stamp and ink as in Experimental Example 1, and microcontact printing was implemented as in Experimental Example 1 to form an electrode pattern.

Five sheet substrates subjected to similar electrode patterning were observed for the formed electrode patterns under an optical microscope. It has consequently been confirmed that there is an electrode width of 9.8 to 10.1 μm obtained with very limited width variations, the reproducibility of stamp line width 10 μm is much more improved, and there is a uniform thickness of 255 to 271 nm obtained: the patterns are formed with much higher precision.

### Experimental Example 3

In the sheet chuck preparation step, a sheet-like material having a plurality of through-holes, instead of the porous material, was fitted over the opening of the recess using an adhesive such that its surface was flush with (shared by) the peripheral surface (holder) of the base. Otherwise, Experimental Example 1 was followed to obtain such an inventive sheet chuck as shown in FIG. 3. The above sheet-like material was formed of an aluminum substrate having through-holes, each of about 100 μm in inside diameter, at a density of one/cm² and a thickness of 2 mm. As a consequence of measuring both surfaces of the above sheet-like material, their R_{P-V} was found to be up to 3 μm, indicating that the sheet-like material is excellent in flatness. It is here to be noted that R_{P-V} was measured under the same conditions as described above.

Such a sheet chuck was used in combination with the same sheet substrate, microcontact printing stamp and ink as in Experimental Example 1, and microcontact printing was implemented as in Experimental Example 1 to form an electrode pattern.

Five sheet substrates subjected to similar electrode patterning were observed for the formed electrode patterns under an optical microscope. It has consequently been confirmed that there is an electrode width of 9.4 to 10.3 μm obtained with very limited width variations, the reproducibility of stamp line width 10 μm is much more improved, and there is a uniform thickness of 263 to 277 nm obtained: the patterns are formed with much higher precision.

What is claimed is:

1. A sheet chuck comprising a base having a sheet substrate carrying surface defined by an upper surface thereof, a suck-in/suck-out port positioned on said carrying surface, and a holder positioned on said carrying surface in such a way as to surround said suck-in/suck-out port, characterized in that said suck-in/suck-out port is an area capable of sucking in or sucking out gas.

2. The sheet chuck according to claim 1, characterized in that a surface of said suck-in/suck-out port extends up from a surface of said holder by a height of 0 to 5 μm.

3. The sheet chuck according to claim 1, characterized in that said holder has an elastic member in such a frame configuration as to surround said suck-in/suck-out port, wherein said elastic member extends up from said holder by a height of up to 20 μm.

4. The sheet chuck according to claim 3, characterized in that said elastic member is positioned in a groove present in said holder.

5. The sheet chuck according to claim 3, characterized in that said elastic member is fixed onto a surface of said holder.

6. The sheet chuck according to claim 1, characterized in that said suck-in/suck-out port comprises a recess, and a porous material positioned in such a way as to close up an opening of said recess, wherein said recess communicates with outside said base via a gas flow channel.

7. The sheet chuck according to claim 6, characterized in that said holder includes an elastic material in such a frame configuration as to surround said suck-in/suck-out port, wherein said elastic material extends up from said holder by up to 20 μm.

8. The sheet chuck according to claim 7, characterized in that said elastic material is positioned in a groove present in said holder.

9. The sheet chuck according to claim 7, characterized in that said elastic member is fixed onto a surface of said holder.

10. The sheet chuck according to claim 1, characterized in that said suck-in/suck-out port comprises a recess and a sheet-like material positioned in such a way as to close up an opening of said recess, wherein said recess communicates with outside said base via a gas flow channel, and said sheet-like material has a plurality of through-holes.

11. The sheet chuck according to claim 10, characterized in that said holder includes an elastic member in such a frame configuration as to surround said suck-in/suck-out port, wherein said elastic member extends up from said holder by a height of up to 20 μm.

12. The sheet chuck according to claim 11, characterized in that said elastic member is positioned in a groove present in said holder.

13. The sheet chuck according to claim 11, characterized in that said elastic member is fixed onto a surface of said holder.

14. A microcontact printing process, characterized by comprising steps of:
providing a sheet chuck comprising a base having a sheet substrate carrying surface defined by an upper surface thereof, a suck-in/suck-out port positioned on said carrying surface, and a holder positioned on said carrying surface in such a way as to surround said suck-in/suck-out port, wherein said suck-in/suck-out port is an area capable of sucking in or sucking out gas, and placing a sheet substrate on said sheet chuck in such a way as to cover up said suck-in/suck-out port with a periphery thereof positioned at said holder,
locating a gap keeper frame onto the sheet substrate positioned at said holder,
sucking in a gas from said suck-in/suck-out port to hold said sheet substrate by suction at said suck-in/suck-out port,
providing a microcontact printing stamp comprising a stamp, transfer convexities formed on said base, and a dummy convex portion positioned at said base in an area around a site having said transfer convexities formed on it, and feeding ink to said transfer convexities of said microcontact printing stamp and implementing alignment of said stamp with said sheet substrate, after which said stamp draws close to said sheet substrate until said dummy convex portion is in abutment onto said gap keeper frame,
sucking out the gas from said suck-in/suck-out port to permit the sheet substrate positioned inside with respect to said gap keeper frame to displace toward said stamp, coming into contact with the ink being fed to said transfer convexities, and
sucking in the gas from said suck-in/suck-out port to space said sheet substrate away from said stamp for transfer of said ink onto said sheet substrate, and holding said sheet substrate at said suck-in/suck-out port and spacing said stamp away.

15. The microcontact printing process according to claim 14, characterized in that said gap keeper frame has a uniform thickness in a range of 20 to 70 μm.

16. The microcontact printing process according to claim 14, characterized in that said sheet chuck having at said holder an elastic member in such a frame configuration as to surround said suck-in/suck-out port is used in combination with a gap keeper frame in such a shape as to be positioned on said elastic member via the sheet substrate.

17. The microcontact printing process according to claim 16, characterized in that said gap keeper frame has a uniform thickness in a range of 20 to 70 μm.
